(19) United States
(12) Patent Application Publication
(10) Pub. No.: US 2004/0027175 A1
(43) Pub. Date: Feb. 12, 2004

(54) Current-voltage converter for the measurement of weak current capable of working under strong x or radiation

(76) Inventors: Pascal Chambaud, Igny (FR); Francis Joffre, Yvette (FR); Mikael Kais, Rueil Malmaison (FR)

Correspondence Address: Hayes Soloway Hennessey, Grossman & Hage, 175 Canal Street, Manchester, NH, 03101, US

(21) Appl. No.: 10/432,576

(22) PCT Filed: Nov. 26, 2001
(86) PCT No.: PCT/FR01/03731

(30) Foreign Application Priority Data
Nov. 28, 2000 (FR) 00 15318

(51) Int. Cl. G01T 1/24

(52) U.S. Cl. 327/103; 250/370.01

(57) ABSTRACT

The invention concerns a current-voltage converter comprising electronic means (3,R) to supply a voltage (Vₒᵤₜ)from a current (Iₚₕ). The converter comprises first means (4, K) to apply or not apply the current at converter input, second means (ECH1) to sample and memorize a voltage (Vₒᵤₜ₁) at converter output when the current is applied at converter input, third means (ECH2) to sample and memorize a voltage (Vₒᵤₜ₂, Vₒᵤₜ₃) at converter output when the current is not applied at converter input, and fourth means (S) for subtracting the voltage sampled and memorized by the third means (ECH2) from the voltage sampled and memorized by the second means (ECH1).

The invention applies more especially to the measurement of weak currents in severe nuclear environments.

### TECHNECAL FIELD AND PRIOR ART

The present invention concerns a current-voltage converter.

More especially, the present invention concerns a current-voltage converter for the measurement of weak currents such as, for example, currents in the range of nanoamps.

There are a number of assemblies which allow carrying out the current-voltage conversion function. These assemblies can be used, for example, for the measurement of currents from radiation detectors.

A radiation detector supplies currents of low values. A preamplifier is then linked to the detector so as to transform the detected current into an amplitude voltage sufficient to transmit or process the signal without risk of degradation. The preamplifier must then maintain a good signal to noise ratio.

In the cases that the preamplifier sustains a considerable dose of X or gamma rays and/or undergoes a considerable rise in the ambient temperature, phenomena of degradation appear. These degradation phenomena are reflected by the appearance of offset voltages at input and at output of the preamplifier and by an increase of polarization currents at the preamplifier input. Furthermore, the gain can also be spoilt.

Several solutions are known at the present time in order to avoid too great a degradation of the measurements carried out on weak currents, for example in severe nuclear environments.

A first solution consists in offsetting the preamplifier assembly outside the radiating milieu in order to guarantee its performance. The difficulty then lies in the need there is to carry out the transport of the weak current along a shielded cable against the ambient electromagnetic perturbations. When the current is very weak and the environment subjected to a high X or gamma radiation, the shielding is generally made with mineral insulating materials which do not permit bending the wires easily. The mineral insulating material is difficult to install, as too great a curvature or just a simple shock generate internal cracks harmful to the mechanical and electrical performance. In other respects, these mineral insulators offer a relatively important diameter.

Another solution consists in using intrinsically hardened technologies like assemblies based on transistors and vacuum tubes. Such an assembly adapted for the high rates of dose is disclosed in the U.S. Pat. No. 5,847,391 entitled “Real Time Radiation Resistant Meter” (Sephton et al.) . The preamplifier is composed of a hardened assembly based on bipolar transistors and vacuum tubes. A system of radio transmission is linked to the assembly. The unit has an advanced hardening and withstands up to 5 MGy of accumulated dose. However, the capacities of such a system are not known regarding the sensitivity of the measurement. Performance is degraded when the amplifier assembly is subjected to the accumulated dose.

A correction of the response of the circuit is necessary. According to this document, one then carries out at regular intervals measurements of reference voltage and temperature measurements. These measurements are used to compensate the drifts of the amplifier assembly as compared with the accumulated dose and the temperature. The correction is made by a system placed outside the radiating milieu. The correction process requires the sending of various data and the processing of this data by an external calculation unit. Independent of this, recourse to vacuum tubes is very restricting and relatively costly. Their service life can be accidentally reduced due to the sensitivity of certain constituents to mechanical vibrations (notably the filaments). The result is problems of reliability. Lastly, the tubes are more expensive than integrated components in silicon on the market and pose a problem of life expectancy.

A third known solution consists in using integrated components on the market. Subjected to the electromagnetic radiation, the efficiency of the components deteriorates very rapidly. It is therefore necessary to replace them regularly. There follows costly maintenance of the converter circuit (regular purchase of new components and immobilization of the circuits in order to install the new components).

The invention does not have the disadvantages mentioned above.

### DESCRIPTION OF THE INVENTION

In fact, the invention concerns a current-voltage converter comprising electronic means to supply a voltage from a current. The current-voltage converter comprises:

first means for applying or not applying the current at converter input,

second means to sample and memorize the voltage at converter output when the current is applied at converter input,

third means to sample and memorize the voltage at converter output when the current has not been applied at converter input, and

fourth means to subtract the sampled and memorized voltage by the third means from the voltage sampled and memorized by the second means.

Thus, the current-voltage converter according to the invention comprises means to supply an output voltage more or less independent of variations of current due to perturbations caused by X rays or gamma radiation and/or through a rise in the ambient temperature.

The current-voltage converter according to the invention produces the same effects as those of a hardening in the way that a reliable operation in compliance with the specifications sheet can be assured, even after reception of accumulated doses greater, for example, than 100 kGy. The “hardening” according to the invention results from the layout of components and functionalities attributed to these components and not from the manufacturing technology of these components. It is thus possible to say, through misuse of language, that the converter as a whole is “hardened” whilst each of its components taken separately is not made according to a hardening technology. Such a hardening makes the installation of the current-voltage converter as near to the system or to the measurement sensor, possible. Problems associated with the transport of a very weak current are therefore conveniently eliminated.

The correction electronics associated with the operational amplifier facilitates eliminating the drifts generated by the degradations of the operational amplifier. The amplified measurement signal obtained in output of the voltage-current converter is then free of the drifts produced by the ionizing radiations and/or the rise in temperature.

According to the preferred realization mode of the invention, the current-voltage converter is made using operational amplifiers. The invention conveniently allows the use of such components for accumulated doses higher than 100 kGy. The preamplifier itself ensures the compensation of drifts generated by the ageing of the operational amplifier and supplies directly a valid measurement without resorting to means of correction located outside the irradiated zone where the equipment is operating.

### SHORT DESCRIPTION OF THE FIGURES

Other characteristics and advantages of the invention will appear on reading of a preferred realization mode of the invention described in reference to the attached figures, among which:

FIG. 1 represents the establishing of currents and voltages in an ideal current-voltage converter connected to an ideal source of voltage, according to the prior art;

FIG. 2 represents the establishing of currents and voltages in a real current-voltage converter connected to a real source of voltage, according to the prior art;

FIG. 3 represents a current-voltage converter according to the invention;

FIG. 4 represents response curves relative to a current-voltage converter according to the invention.

### DETAILED DESCRIPTION OF THE IMPLEMENTATION MODE OF THE INVENTION

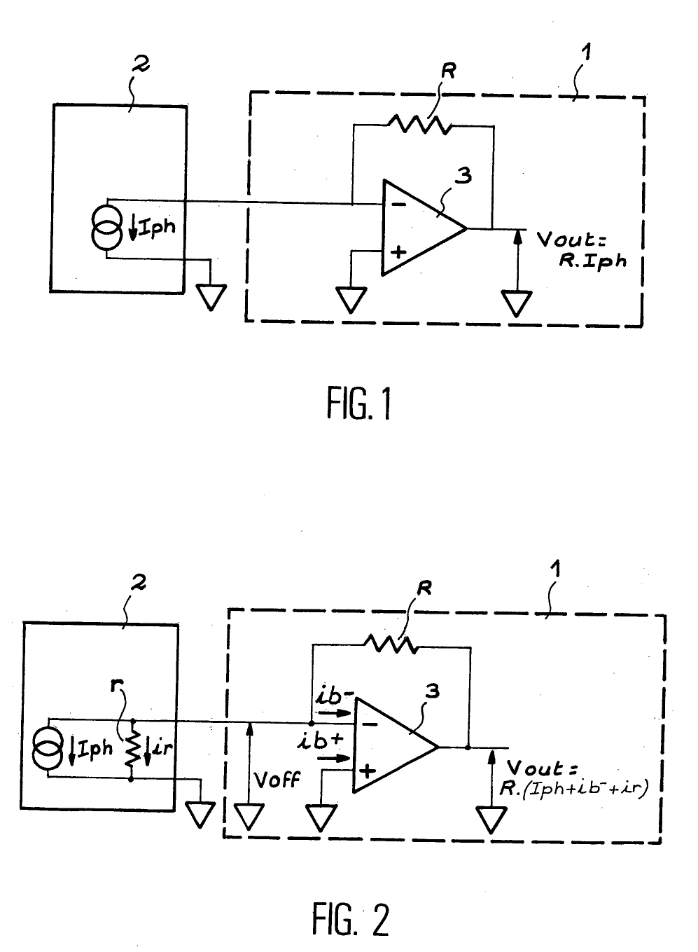

FIG. 1 represents the establishing of currents and voltages in an ideal current-voltage converter connected to an ideal source of voltage, according to the prior art.

The converter 1 comprises an operational amplifier 3 and a feedback resistor R. The operational amplifier 3 has a non-inverter input (+) connected to the mass and an inverter input (−) connected to the source 2 of current Iₚₕ. The resistor R is mounted between the inverter input (−) and the operational amplifier 3 output.

Such a current-voltage assembly is capable of measuring with precision very weak currents (for example, currents in the region of 10⁻⁹ amps) The operational amplifier 3 is preferably in bipolar technology notably with a JFET first stage input. The source of current Iₚₕ symbolizes the current from a detector, for example one or several semiconductor junctions susceptible to being subjected to an X ray or gamma radiation. A quasi-nil voltage is maintained at the amplifier 3 input whilst the assembly is supplied and polarized adequately. On the assumption that the difference of potential between the inverter and non-inverter inputs is equal to 0 volt (ideal case), the voltage sampled at the operational amplifier 3 output is Vₒᵤₜ, such that:

Vₒᵤₜ=R×Iₚₕ

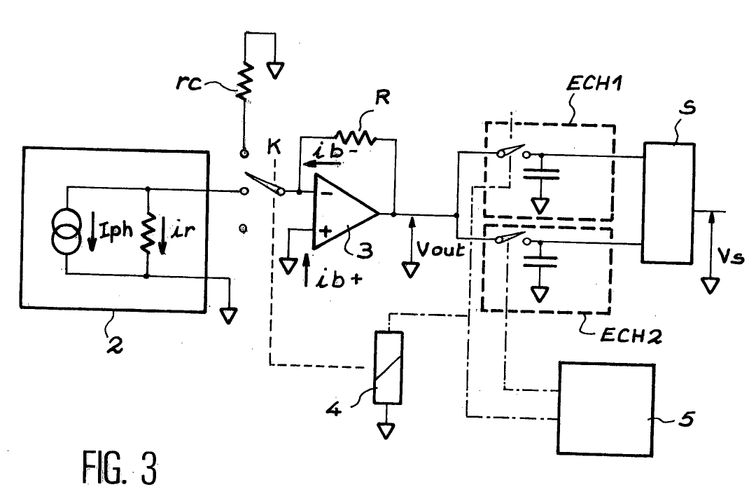

FIG. 2 represents establishing currents and voltages in a real current-voltage converter connected to a real source of current, according to the prior art.

A polarization current i_{b-} is present on the inverter input (−) and a polarization current i_{b+} is present on the non-inverter input (+). In other respects, an offset voltage V_{off} is present between the inverter input (−) and the mass of the circuit.

FIG. 2 facilitates explaining the transfer function of a real current-voltage converter according to the prior art and, therefore, the effect of perturbations (irradiation, considerable temperature rise) on this transfer function.

The voltage on the amplifier 3 output is expressed:

Vₒᵤₜ=R×(Iₚₕ+iᵣ+i_{b-}), where iᵣ=V_{off}/r

with r the internal resistance of the source of current 2.

In most cases, iᵣ and i_{b-} are negligible as compared to Iₚₕ, even when the latter has a low value, for example in the region of 10⁻⁹ Amps. On the other hand, the disturbing effect induced, for example by an ionizing radiation and/or by a rise in the ambient temperature, results in that iᵣ and/or i_{b-} are no longer negligible as compared to Iₚₕ. There then appears a considerable drift of the output voltage Vₒᵤₜ. This drift is essentially linked to the increase of the polarization currents i_{b-} and i_{b+} of the input first stage of the operational amplifier 3 and/or of the leakage current iᵣ due to the offset voltage V_{off} applied to the terminals of r.

In the case where the phenomenon of irradiation is involved, after several kGy of accumulated dose, the value of the current i_{b-} becomes significant compared to the current Iₚₕ. In the same way, the offset voltage V_{off} increases, generating a current iᵣ which is no longer negligible. The i_{b-} and iᵣ currents are added to the Iₚₕ current. The output voltage Vₒᵤₜ drifts then according to the formula shown above.

Under the effect of a thermal disturbance, similar drifts are observed. The disturbances caused either by irradiation or because of thermal drifts go, for most of the amplifiers, in the same direction and are therefore added together.

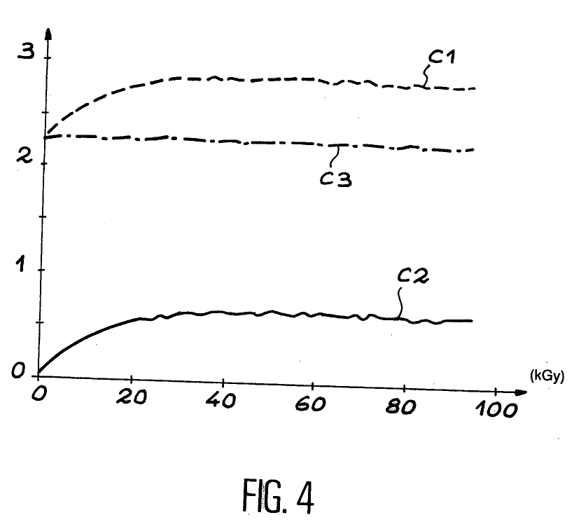

FIG. 3 represents a current-voltage converter according to the invention.

The current-voltage converter according to the invention comprises electronic means of correction constituted by components not intrinsically hardened which makes it possible to provide a stable measurement in relation to the accumulated dose. A stable measurement consists in maintaining the output voltage Vₛ of the current-voltage converter more or less constant whatever the variations caused by the operational amplifier circuit 3.

The electronic means of correction comprise a contact K, a relay 4, a sequencer circuit 5, two sample-and-hold circuits ECH1, ECH2 and a subtracter S. It should be noted here that one would not leave the frame of the invention by replacing the relay 4 by a semiconductor power device fulfilling the same function of commutation, the semiconductor device having very weak leakage currents.

The workings of the compensation circuit are based on the commutation of the relay 4. The control of the relay 4 is ensured by the sequencer circuit 5. The sequencer circuit 5 commands the coil of the relay 4 with an opening/closure cycle of equal length, for example, several seconds. The contact K of the relay 4 means that the inverter input of the operational amplifier 3 is connected or not to the source of current 2. When the inverter input is not connected to the source of current, it is either free or connected to a load resistor rc whose value is, preferably, more or less equal to the value of the resistor r.

During the phase where the contact K is closed on the source 2, the output voltage of the amplifier 3 is Vₒᵤₜ₁ such that:

Vₒᵤₜ₁=R×(Iₚₕ+i_{b-}+iᵣ ) where iᵣ=V_{off}/r

During the phase where the contact K is not closed on the source 2, the output voltage of the amplifier 3 is:

either Vₒᵤₜ₂=R×(i_{b-}+i_{c}) where i_{c}=V_{off}/r_{c} in the case where the contact K is closed on the resistor r_{c},

or Vₒᵤₜ₃=R×i_{b-} the case where the contact K is free.

According to the invention, when the current iᵣ is negligible compared to the currents Iₚₕ and i_{b-}, the output voltage after correction is obtained by subtracting the voltage Vₒᵤₜ₃ from the voltage Vₒᵤₜ₁.

In the same way, when the current iᵣ is not negligible compared to the currents Iₚₕ and i_{b-}, the output voltage after correction is obtained by subtracting the voltage Vₒᵤₜ₂ from the voltage Vₒᵤₜ₁.

As a non-restrictive example, continuation of the description will be made in the case where the current iᵣ is not considered as negligible compared to the currents Iₚₕ and i_{b-}.

According to the invention, the voltages Vₒᵤₜ, and Vₒᵤₜ₂ are then successively sampled and memorized by the respective sample-and-hold circuits ECH1 and ECH2.

The two sample-and-hold circuits ECH1 and ECH2 are controlled by the sequencer 5. The command of the relay 4 is preferably synchronous with the command of the sample-and-hold circuits ECH1 and ECH2. It should be noted here that one would not leave the frame of the present invention by allocating to the voltage-current converter means in order to stagger the sampling moments of sample-and-hold circuits ECH1 and ECH2 from the switch-over toggle moments of the contact K, in order not to generate a measurement noise.

The sample-and-hold circuit ECH1 samples and memorizes the voltage at the operational amplifier 3 output when the contact K of the relay 5 is closed on the source of current 2.

The sample-and-hold circuit ECH2 samples and memorizes the voltage at the operational amplifier 3 output when the contact K of the relay 5 is closed on the resistor r_{c}.

A subtracting function then facilitates reverting to the significant value of the current Iₚₕ at current-voltage converter output. One arrives at:

Vₛ=Vₒᵤₜ₁−Vₒᵤₜ₂=[R×(Iₚₕ+i_{b-}+iᵣ)]−[R×(i_{b-}+i_{c})]

i.e. on the assumption that iᵣ=i_{c} (i.e. r=r_{c}):

Vₛ=R×Iₚₕ

According to the preferred realization mode of the invention, the subtraction of voltages Vₒᵤₜ₁, and Vₒᵤₜ₂ is carried out by a subtracter S, for example an operational amplifier.

The resistors R and r_{c} are resistors whose values are independent of radiation conditions and, if necessary, such that R depends little on the temperature and that r_{c} has a thermal resistance near to that of r. The voltage Vₛ is therefore very much proportionate to the current Iₚₕ. Conveniently, the current-voltage converter according to the invention makes it possible to remove any drift linked to variations of polarization currents and offset voltages at the amplifier input. It is therefore possible, in particular, to remove drifts associated with temperature variations.

The subtracter S is preferably made using JFET bipolar technology.

A characterization under gamma radiation of the current-voltage conversion circuit according to the invention has been carried out. The source of radiation used is a ⁶⁰Co source. Measurements of the drift of the polarization currents of the current-voltage assembly have been made. Curves C1, C2, C3 represented in FIG. 4 show respectively, for a constant dose rate of 1 KGy/h, the voltage measurements depending on the accumulated dose carried out at output of the sample-and-hold circuit ECH1, at output of the sample-and-hold circuit ECH2 and at output of the subtracter S. The current Iₚₕ measured is equal to 90 nA. The maximum accumulated dose obtained is near to 100 kGy. The measurements have been made at an ambient temperature of 25° C.

Curve C1 represents measurement of the voltage made at output of the sample-and-hold circuit ECH1 assembly. This is therefore the measurement made with the current-voltage assembly when the latter is connected to the source of current 2.

Curve C2 represents measurement of the voltage made at output of the sample-and-hold circuit ECH2 assembly. This is therefore the measurement made with the current-voltage assembly when the latter is not connected to the source of current 2. It appears on this curve that the sum of the currents i_{b-} and iᵣ evolve strongly from the first kGy of accumulated dose.

Curve C3 represents measurement of the voltage made at output of the subtracter S. It appears clearly that the voltage measured at subtracter output is the difference between the voltage at output of the sample-and-hold circuit ECH1 and the voltage at output of the sample-and-hold circuit ECH2.

The principle of memorization and correction of the offsets according to the invention can be applied in the case of difficult thermal stresses. The compensation circuit according to the invention therefore guarantees conveniently a constant output voltage independent of the thermal environment on the proviso that R has a low thermal coefficient and that r and r_{c} have similar thermal behaviors.

The current-voltage converter assembly according to the invention is particularly suited, for example, to measurement of continuous or low frequency signals. The frequency response or pass-band is limited by the commutation speed of the relay which can be, for example, several seconds. This duration defines the frequency of sampling and blocking of the sample-and-hold circuits ECH1 and ECH2. The current-voltage converter hardened at 100 kGy can be used in an irradiated environment. It can be linked to a detection circuit as a preamplifier sensor. The detector/sensor link can conveniently be reduced to the minimum. The sensor converter assembly can be built into the same box thus improving performance in relation to electrical interferences.

The current-voltage converter according to the invention is particularly suitable for dealing with the very weak currents generated by at least one semiconductor junction capable of generating hole-electron pairs under the exposure of a radiation to be detected, connected in photovoltaic mode and maintained at a more or less constant temperature by recognized means. Such a junction then behaves like a detector of X ray or γ radiation, and the detector junction/converter unit according to the invention becomes an X ray or γ radiation sensor monitor. Resistance of the junction (or junctions) to ionizing radiation and its measurement sensitivity are greatly improved when this more or less constant temperature is higher than the ambient temperature and lower than its maximum operating temperature. It is convenient to be sure that this temperature is as constant as possible through known means of regulation which can be placed outside the zone where the radiation, object of the measurement, subsists.

Through connection in photovoltaic mode, one must understand not only the case where the junction is closed in on an ohmic resistance of very weak value but also the case where the junction is shut in on an electronic circuit capable of maintaining a quasi-nil difference of potential between its terminals like the converter, subject of the invention.

1. Current-voltage converter comprising electronic means (3, R) to supply a voltage (Vₒᵤₜ) from a current (Iₚₕ) , characterized in that it comprises:
first means (4, K) to apply or not apply the current at converter input,
second means (ECH1) to sample and memorize a voltage (Vₒᵤₜ₁) at converter output when the current (Iₚₕ) is applied at converter input,
third means (ECH2) to sample and memorize a voltage (Vₒᵤₜ₂, Vₒᵤₜ₃) at converter output when the current (Iₚₕ) is not applied at converter input, and
fourth means (S) for subtracting the voltage sampled and memorized by the third means (ECH2) from the voltage sampled and memorized by the second means (ECH1).

2. Current-voltage converter according to claim 1, characterized in that the first means (4, K) are constituted by a relay (4) contact (K), in that the second means are constituted by a first sample-and-hold circuit (ECH1) having an input and an output, in that the third means are constituted by a second sample-and-hold circuit (ECH2) having an input and an output, the input of the first sample-and-hold circuit being connected to the input of the second sample-and-hold circuit, and in that the fourth means are constituted of a subtracter (S) having a first input connected to the output of the first sample-and-hold circuit (ECH1) and a second input connected to the output of the second sample-and-hold circuit (ECH2).

3. Converter according to claim 2, characterized in that it comprises a sequencer (5) which synchronizes the command of the contact (K) with the command of the sample-and-hold circuits (ECH1, ECH2).

4. Converter according to any one of the preceding claims, characterized in that the electronic means (3, R) to supply a voltage from a current are constituted by an operational amplifier (3) having an inverter input and an output and by a resistor (R) installed between the inverter input and the output of the operational amplifier (3).

5. Converter according to any one of claims 2 to 4, characterized in that the subtracter (S) comprises an operational amplifier.

6. Converter according to any one of the preceding claims, characterized in that the converter input is free when the current is not applied at converter input.

7. Converter according to any one of claims 1 to 5, characterized in that the converter input is connected to a load resistor (r_{c}) when the current is not applied at converter input.

8. Converter according to claim 7, characterized in that the load resistor (r_{c}) has a value more or less equal to the internal impedance (r) of a current generator (2) which supplies the current to be converted.

9. X or γ radiation sensor comprising at least one semiconductor junction capable of generating hole-electron pairs under the effect of a detected radiation, connected in photovoltaic mode and maintained at a more or less constant temperature, characterized in that it comprises a current-voltage converter according to any one of the preceding claims.

10. X or γ radiation sensor according to claim 9, characterized in that the more or less constant temperature is higher than the ambient temperature.
